(19) United States
(12) Patent Application Publication
(10) Pub. No.: US 2025/0139977 A1
(43) Pub. Date: May 1, 2025

(54) CROWD COUNTING SYSTEM AND A METHOD OF OPERATING A CROWD COUNTING SYSTEM

(71) Applicant: Hendricks Corp. Pte. Ltd., Singapore (SG)

(72) Inventor: Souhail Meftah, Singapore (SG)

(73) Assignee: Hendricks Corp. Pte. Ltd., Singapore (SG)

(21) Appl. No.: 18/919,075

(22) Filed: Oct. 17, 2024

(30) Foreign Application Priority Data
Oct. 25, 2023 (SG) 10202303021T

(51) Int. Cl. G06V 20/52; G06V 10/26

(52) U.S. Cl. CPC G06V 20/53; G06V 10/26

(57) ABSTRACT

An aspect of the present disclosure provides a crowd counting system. The system includes at least one processor, and at least one memory including computer program code. The at least one processor, at least one memory and the computer program code are configured to allow the system to receive an image depicting a crowd, determine if a crowd density variation exists within the image based on a predetermined threshold for crowd density variation, partition the image into a plurality of image segments based on predefined crowd density ranges in response to a positive determination of the crowd density variation, each image segment corresponding to a predefined crowd density range, determine a crowd size within each image segment using a crowd counting algorithm associated with crowd density range of the image segment, wherein each predefined crowd density range is associated with a respective crowd counting algorithm, and determine the crowd size in the image by summing the crowd size in each of the plurality of image segments.

### TECHNICAL FIELD

The present invention generally relates to a crowd counting system and a method of operating a crowd counting system.

### BACKGROUND ART

Accurate crowd counting is important for various applications, including event management, public safety, and urban planning. In large-scale events, knowing the number of attendees and their distribution can support effective crowd control and safety measures. In public safety operations, understanding crowd movement is important during emergency evacuations or disaster response. Similarly, urban planners rely on accurate crowd data to design infrastructure, such as transport hubs and public spaces, to better manage pedestrian flow and to accommodate people more efficiently.

However, traditional crowd counting systems and methods face several challenges. These systems and methods often struggle to adapt to varying crowd densities within a single image or video frame. In densely packed areas, individuals may be obscured, making it difficult to provide accurate counts. Conversely, in sparsely populated areas, gaps between people may lead to over-counting. As a result, these systems and methods can produce inconsistent and unreliable crowd estimates, especially when dealing with fluctuating densities across different regions of the same image.

The complexity of crowd counting often increases significantly when multiple cameras are deployed, each offering a different perspective and field of view. Variations in camera angles, distances from the crowd, and image quality can greatly impact the accuracy of results. Cameras positioned closer to the crowd capture finer details, while those positioned farther away may produce incomplete or lower-resolution images, making it difficult to accurately count individuals. Furthermore, overlapping areas between camera views can create redundancy or cause double counting, while blind spots or missing sections in the coverage can result in undercounting.

Accordingly, what is needed is a crowd counting system and a method of operating a crowd counting system that seek to address some of the above problems. Furthermore, other desirable features and characteristics will become apparent from the subsequent detailed description and the appended claims, taken in conjunction with the accompanying drawings and this background of the disclosure.

### SUMMARY OF INVENTION

An aspect of the present disclosure provides a crowd counting system. The system includes at least one processor, and at least one memory including computer program code. The at least one processor, at least one memory and the computer program code are configured to allow the system to receive an image depicting a crowd, determine if a crowd density variation exists within the image based on a predetermined threshold for crowd density variation, partition the image into a plurality of image segments based on predefined crowd density ranges in response to a positive determination of the crowd density variation, each image segment corresponding to a predefined crowd density range, determine a crowd size within each image segment using a crowd counting algorithm associated with crowd density range of the image segment, wherein each predefined crowd density range is associated with a respective crowd counting algorithm, and determine the crowd size in the image by summing the crowd size in each of the plurality of image segments.

To determine if a crowd density variation exists within the image, the system can be configured to divide the image into a plurality of tiles, determine a crowd density of each tile using a density classification algorithm, and compare a variation of the determined crowd densities against the predetermined threshold for crowd density variation.

To divide the image into a plurality of tiles, the system can be configured to divide the image into the plurality of tiles with an overlap between edges of adjacent tiles.

To partition the image into the plurality of image segments, the system can be configured to partition the image along edges of the plurality of tiles into the plurality of image segments based on the predefined crowd density ranges, wherein each image segment includes one or more tiles and corresponds to a predefined crowd density range.

To divide the image into a plurality of tiles, the system can be configured to divide the image into a first set of tiles at a first resolution and a second set of tiles at a second resolution. To determine the crowd size in the image, the system can be configured to determine the crowd size in the image by averaging the summed crowd size associated with the first set of tiles and the summed crowd size associated with the second set of tiles.

Each predefined crowd density range can be determined based on the crowd counting algorithm optimised for accuracy within said crowd density range.

Each crowd counting algorithm can be optimised for one or more environmental conditions consisting of time, weather and location. To determine the crowd size within each image segment, the system can be configured to determine one or more environmental conditions of the image or the image segment, and determine the crowd size within each image segment using a crowd counting algorithm associated with crowd density range of the image segment and the one or more determined environmental conditions of the image or the image segment.

The system can be further configured to upsample the image depicting a crowd before determining the crowd density variation and/or one or more of the plurality of image segments before determining the crowd size.

The image can include a video frame depicting the crowd, the video frame being one of a plurality of video frames extracted from a video stream.

An aspect of the present disclosure provides a method of operating a crowd counting system. The method includes receiving, by a processing device, an image depicting a crowd, determining, using the processing device, if a crowd density variation exists within the image based on a predetermined threshold for crowd density variation, in response to a positive determination of the crowd density variation, partitioning, using the processing device, the image into a plurality of image segments based on predefined crowd density ranges, each image segment corresponding to a predefined crowd density range, determining, using the processing device, a crowd size within each image segment using a crowd counting algorithm associated with crowd density range of the image segment, wherein each predefined crowd density range is associated with a respective crowd counting algorithm, and determining, using the processing device, the crowd size in the image by summing the crowd size in each of the plurality of image segments.

The step of determining if a crowd density variation exists within the image can include dividing, using the processing device, the image into a plurality of tiles, determining, using the processing device, a crowd density of each tile using a density classification algorithm, and comparing, using the processing device, a variation of the determined crowd densities against the predetermined threshold for crowd density variation.

The step of dividing the image into the plurality of tiles can include dividing, using the processing device, the image into the plurality of tiles with an overlap between edges of adjacent tiles.

The step of partitioning the image into the plurality of image segments based on the predefined crowd density ranges can include partitioning, using the processing device, the image along edges of the plurality of tiles into the plurality of image segments based on the predefined crowd density ranges, wherein each image segment includes one or more tiles and corresponds to a predefined crowd density range.

The step of dividing the image into a plurality of tiles can include dividing, using the processing device, the image into a first set of tiles at a first resolution and a second set of tiles at a second resolution. The step of determining the crowd size in the image can include determining, using the processing device, the crowd size in the image by averaging the summed crowd size associated with the first set of tiles and the summed crowd size associated with the second set of tiles.

Each predefined crowd density range can be determined based on the crowd counting algorithm optimised for accuracy within said crowd density range.

Each crowd counting algorithm can be optimised for one or more environmental conditions consisting of time, weather and location, and the step of determining the crowd size within each image segment using a crowd counting algorithm associated with crowd density range of the image segment can include determining, using the processing device, one or more environmental conditions of the image, and determining, using the processing device, the crowd size within each image segment using a crowd counting algorithm associated with crowd density range of the image segment and the one or more determined environmental conditions of the image.

The method can further include upsampling, using the processing device, the image depicting a crowd before determining the crowd density variation and/or one or more of the plurality of image segments before determining the crowd size.

The image can include a video frame depicting the crowd, the video frame being one of a plurality of video frames extracted from a video stream.

### BRIEF DESCRIPTION OF DRAWINGS

Embodiments of the invention will be better understood and readily apparent to one of ordinary skill in the art from the following written description, by way of example only, and in conjunction with the drawings, in which:

FIG. 1 shows a schematic diagram of a crowd counting system, in accordance with embodiments of the disclosure.

FIG. 2 shows a schematic diagram of an example implementation of the crowd counting system of FIG. 1, in accordance with embodiments of the disclosure.

FIG. 3 shows a flowchart illustrating a method of operating a crowd counting system, in accordance with embodiments of the disclosure.

FIGS. 4A, 4B and 4C show exemplary illustrations of crowd counting methods, in accordance with embodiments of the disclosure. FIG. 4D shows an example implementation of the crowd counting system of FIG. 1, in accordance with embodiments of the disclosure.

FIG. 5 shows a schematic diagram of a computing device used to realise the system of FIG. 1.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

Embodiments of the present invention will be described, by way of example only, with reference to the drawings. Like reference numerals and characters in the drawings refer to like elements or equivalents. The following detailed description is merely exemplary in nature and is not intended to limit the invention or the application and uses of the invention. Furthermore, there is no intention to be bound by any theory presented in the preceding background of the invention or the following detailed description. Herein, a modular fluid processing tank is presented in accordance with present embodiments having the advantages of transportability, modularity and scalability.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “associating”, “calculating”, “comparing”, “determining”, “forwarding”, “generating”, “detecting”, “including”, “inserting”, “modifying”, “receiving”, “replacing”, “retrieving”, “scanning”, “storing”, “transmitting” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may include a computer or other computing device selectively activated or reconfigured by a computer program stored therein. The algorithms and displays presented herein are not inherently related to any particular computer or other apparatus. Various machines may be used with programs in accordance with the teachings herein. Alternatively, the construction of more specialised apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on a computer effectively results in an apparatus that implements the steps of the preferred method.

In embodiments of the present invention, use of the term ‘server’ may mean a single computing device or at least a computer network of interconnected computing devices which operate together to perform a particular function. In other words, the server may be contained within a single hardware unit or be distributed among several or many different hardware units.

The term “configured to” is used in the specification in connection with systems, apparatus, and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For special-purpose logic circuitry to be configured to perform particular operations or actions means that the circuitry has electronic logic that performs the operations or actions.

Embodiments of the present disclosure provide a crowd counting system and a method for operating a crowd counting system that can address the challenges of crowd counting. The system in accordance with embodiments of the invention can be configured to analyse images or video frames depicting a crowd, select for and apply the most appropriate crowd counting methods based on the specific characteristics of the images or sections of the images. Advantageously, the crowd counting system in accordance with embodiments of the invention can provide accurate and reliable crowd counting, particularly in environments with varying crowd densities.

Embodiments of the present disclosure also relates to use of neural networks, hereinafter interchangeably referred to as artificial intelligence (AI) in the field of video analytics. Embodiments of the present disclosure can include processing data in the form of images or video from either live sources (e.g., image capturing devices such as security cameras) or stored media (e.g., mp4 files) and generating insights to enhance crowd control and security measures. For example, the crowd counting system in accordance with embodiments of the present disclosure can provide statistics on crowd numbers and density at specific locations, the distribution of crowd load across platforms, and whether sufficient personal space is available based on the crowd density and the area of the location.

In exemplary embodiments, the images or video frames can include, but is not limited to any visual representation that captures a scene containing a plurality of individuals. The image or video frames may be obtained from various sources such as cameras, sensors, other imaging devices, or image or video storage devices. The images or video frames can include, but is not limited to, different perspectives, resolutions, and scales, and may involve different levels of crowd density across the images or video frames. Hereinafter, the term “image” can be referred to interchangeably as an image or a video frame. In exemplary embodiments, the video frames can be extracted by the crowd counting system at a predetermined frame interval.

In exemplary embodiments, crowd counting refers to the process of counting or estimating the number of individuals present in an image or video frame. This process may involve detecting and counting individuals in various environments, even in cases where crowd densities fluctuate, or individuals are obscured. Crowd counting, as will be described in detail below, may use different algorithms designed to handle conditions such as fluctuating crowd densities and varying environments to provide accurate and reliable estimates. The data obtained from crowd counting can be utilised for crowd analytics. Crowd analytics refers to the process of processing and analysing data related to the behaviour, movement, and characteristics of a crowd in a particular environment. This data can be derived from sources such as images and video footage and is used to for applications including crowd management, public safety, and urban planning. Analytics may include assessing data such as crowd density, movement patterns, and distribution to optimise and improve performance and efficiency of crowd control methods.

In exemplary embodiments, the crowd counting system can include at least one processor, and at least one memory including computer program code. The at least one processor, at least one memory and the computer program code are configured to allow the system to (i) receive an image depicting a crowd, (ii) determine if a crowd density variation exists within the image based on a predetermined threshold for crowd density variation, and in response to a positive determination of the crowd density variation, (iii) partition the image into a plurality of image segments based on predefined crowd density ranges, each image segment corresponding to a predefined crowd density range, (iv) determine a crowd size within each image segment using a crowd counting algorithm associated with crowd density range of the image segment, wherein each predefined crowd density range is associated with a respective crowd counting algorithm and (v) determine the crowd size in the image by summing the crowd size in each of the plurality of image segments.

Embodiments of the present disclosure also seek to address the identified subproblems associated with crowd counting and analytics. Embodiments of the present disclosure can include a range of detection and estimation methods hereinafter interchangeably referred to as crowd counting methods or crowd counting algorithms. The methods include small person detection methods, small face detection methods, crowd counting and estimation methods. For small person detection, various algorithms, such as bottom-heavy neural networks and scale selection pyramid networks, can be used to enhance the accuracy of locating small individuals within an image frame. Small face detection methods can include training detectors in multi-task fashion or using a pre-identification mechanism and cascaded detector to improve the identification of small faces in images. Crowd counting and estimation methods can include compression algorithms that can refine features and obtain spatial and numerical distribution of crowd-specific information. Thus, embodiments of the present disclosure can address the following subproblems: (i) small person detection, which involves identifying small objects in an image frame and recognising them as individuals through bounding box applications; (ii) small face detection, which involves applying bounding boxes to small objects in an image and recognising them as faces; (iii) crowd detection, which involves identifying portions of an image that contain crowds through the application of bounding boxes; and (iv) crowd estimation, which refers to the accurate counting or estimation of the number of individuals within the defined crowd bounding boxes. In embodiments, algorithms can be configured to use the identified bounding boxes and crowd counts to execute tasks such as calculating entry and exit numbers, determining occupancy levels within a specified location over a defined time duration, and generating real-time heatmaps, dashboards, and alerts. The data can be used to generate analytics and statistical outputs which can in turn be used to enhance operational efficiency and automate crowd management processes.

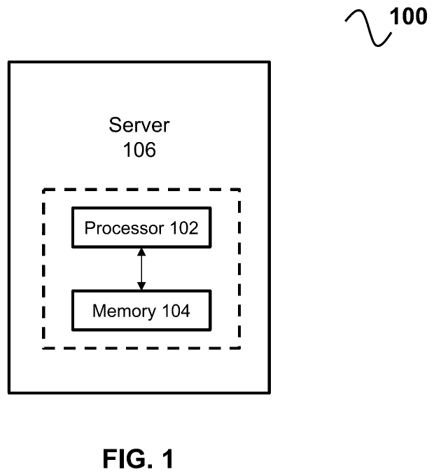

FIG. 1 shows a schematic diagram of a crowd counting system 100, in accordance with embodiments of the disclosure. In exemplary embodiments, the system 100 can include at least one processor 102 and at least one memory 104 including computer program code. The at least one processor 102 and the at least one memory 104 can be housed in a server 106. The at least one processor 102, at least one memory 104 and the computer program code are configured to allow the system 100 to (i) receive an image depicting a crowd, (ii) determine if a crowd density variation exists within the image based on a predetermined threshold for crowd density variation, and in response to a positive determination of the crowd density variation, (iii) partition the image into a plurality of image segments based on predefined crowd density ranges, each image segment corresponding to a predefined crowd density range, (iv) determine a crowd size within each image segment using a crowd counting algorithm associated with crowd density range of the image segment, wherein each predefined crowd density range is associated with a respective crowd counting algorithm and (v) determine the crowd size in the image by summing the crowd size in each of the plurality of image segments. In other words, the system 100 in accordance with embodiments of the disclosure can determine if there are variations in crowd density (i.e., whether some areas in the image have more people than others). This can be done by comparing the image to a predefined threshold for crowd density variation. If the threshold is met (i.e., the system 100 determines that different parts of the image have different crowd densities that are more than the predefined set value), the system can partition the image into multiple segments, each segment corresponding to a specific predefined crowd density range. For each segment, the system 100 can use a specific crowd counting algorithm based on the crowd density in that segment. As will be explained in detail below, each crowd density range is associated with a specific crowd counting algorithm configured to handle said range. That is, each predefined crowd density range can be determined based on the crowd counting algorithm optimised for accuracy within said crowd density range (i.e. the crowd counting algorithm is configured to achieve accurate and consistent results for a set of crowd density values corresponding to the defined range). In an alternative embodiment, the crowd density range may be user-defined and the system can associate the user-defined crowd density range with a specific crowd counting algorithm configured to handle said range.

In example embodiments, to determine if a crowd density variation exists within the image, the system 100 can also be configured to (i) divide the image into a plurality of tiles, (ii) determine a crowd density of each tile using a density classification algorithm and (iii) compare a variation of the determined crowd densities against the predetermined threshold for crowd density variation. In an example embodiment, the system 100 can be configured to divide the image into the plurality of tiles with an overlap between edges of adjacent tiles. In other words, the system can divide the image into the plurality of tiles such that there is an overlap between edges of adjacent tiles. Advantageously, the overlap can capture persons that may be partially visible at the edges of one tile and can reduce the chances of missing or inaccurately counting persons that are positioned near the borders between tiles.

In example embodiments, to partition the image into the plurality of image segments, the system 100 can be configured to partition the image along edges of the plurality of tiles into the plurality of image segments based on the predefined crowd density ranges, such that each image segment comprises one or more tiles and corresponds to a predefined crowd density range. That is, in example embodiments, the system 100 can partition the image by grouping tiles with similar crowd densities into larger image segments. The segments are grouped along the edges of the tiles, and each segment corresponds to a predefined crowd density range to allow the system 100 to apply the appropriate counting algorithms for each segment based on its crowd density.

In example embodiments, to divide the image into a plurality of tiles, the system 100 can be configured to divide the image into a first set of tiles at a first resolution and a second set of tiles at a second resolution. To determine the crowd size in the image, the system 100 can be configured to determine the crowd size in the image by averaging the summed crowd size associated with the first set of tiles and the summed crowd size associated with the second set of tiles. Advantageously, by dividing the image into tiles at two (or more) different resolutions, the system 100 can capture both broad and fine-grained details at different scales. The system can determine the crowd size in each of the tiled images at the different resolutions with respective crowd counting algorithms that are effective at different resolutions. The final crowd size can be determined by averaging the results across the different sets of tiled images, and thus can provide a more accurate crowd counting across the entire image.

In example embodiments, each predefined crowd density range is determined based on the crowd counting algorithm optimised for accuracy within said crowd density range. That is, for each predefined crowd density range, the system 100 can use a specific crowd counting algorithm optimised for accuracy within the particular density range. In example embodiments, the algorithm used for crowd counting in high crowd density areas can differ from the one applied in low crowd density areas, as each algorithm is configured to address the challenges associated with the respective densities. By applying algorithms tailored to each crowd density range, the system can ensure a high level of accuracy in crowd counting across varying density conditions in the image.

In example embodiments, each crowd counting algorithm can be optimised for one or more environmental conditions including, but not limited to time, weather and location. To determine the crowd size within each image segment, the system can be configured to determine one or more environmental conditions of the image or the image segment, and determine the crowd size within each image segment using a crowd counting algorithm associated with crowd density range of the image segment and the one or more determined environmental conditions of the image or the image segment. In other words, the system 100 can include algorithms optimised for specific environmental conditions including time, weather, and location. The system 100 can be configured to determine the relevant environmental conditions for each image or each image segment, and apply the appropriate crowd counting algorithm associated with both the crowd density range of the image segment and the identified environmental conditions. Advantageously, the approach can ensure that the crowd counting algorithm is adapted to the specific conditions which the image segment captures, thereby enhancing the accuracy of the crowd count across varying environmental scenarios.

In example embodiments, the system 100 can also be configured to upsample the image depicting a crowd before determining the crowd density variation and/or one or more of the plurality of image segments before determining the crowd size. In other words, the system 100 can be configured to increase the resolution of the image or image segments, to allow for additional detail and improved accuracy in crowd counting.

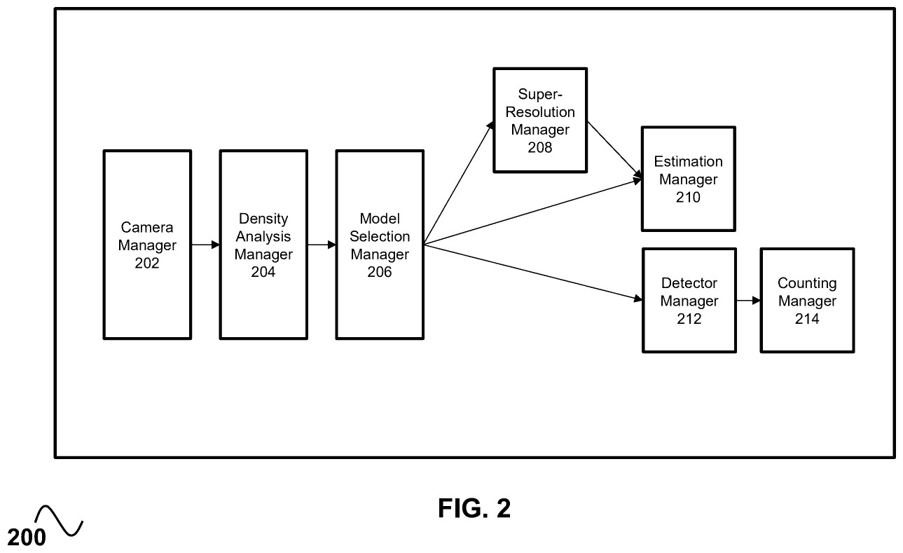

FIG. 2 shows a schematic diagram of an example implementation of the crowd counting system 100 of FIG. 1, in accordance with embodiments of the disclosure. The crowd counting system 100 can be configured to run a crowd counting application 200 which includes a set of instructions in machine-readable format that is executable by the crowd counting system 100 to perform the various functions described herein. In exemplary embodiments, the crowd counting 100 can be configured to analyse images or video frames depicting a crowd, select for and apply the most appropriate crowd counting methods based on the specific characteristics of the images or sections of the images, and provide an estimate of the crowd size.

The crowd counting application 200 in accordance with embodiments of the disclosure can include one or more managers, each being a subroutine or program configured to perform one or more specific functions within the application. Each of the one or more managers can include instructions in machine-readable format that is executable by the crowd counting application 200 to perform the various functions described in more detail below. In an example embodiment as shown in FIG. 2, the crowd counting application 200 can include, but is not limited to, camera manager 202, density analysis manager 204, model selection manager 206, super-resolution manager 208, estimation manager 210, detector manager 212 and counting manager 214.

In an embodiment of the present disclosure, the camera manager 202 can cause the crowd counting system 100 to receive a video stream from a respective video source (e.g. a camera or a server storing a video stream), process the video stream and transmit images or video frames of the video stream to the density analysis manager 204. The camera manager 202 can also manage camera settings (e.g. adjust resolution or frame rate), initiate or terminate video streams, and allocate processing resources to ensure efficient operation (e.g. to maximize hardware utilisation or minimise delays). In embodiments, the management of camera settings can include adjusting camera parameters such as focus, zoom, and exposure, either automatically based on detected conditions or manually through user input. In an embodiment, the camera manager 202 can cause the crowd counting system 100 to at least receive an image depicting a crowd. In an embodiment, the video stream can include pre-recorded videos sampled on a configurable frame interval, wherein video frames extracted from the video stream are processed as images by the camera manager 202.

The density analysis manager 204 in accordance with embodiments of the present disclosure can cause the crowd counting system 100 to receive image frames from the camera manager 202 and analyse crowd density distribution across the image using the density classification algorithm. Results of this analysis are transmitted to the model selection manager 206, which can cause the crowd counting system 100 to select the most appropriate method or algorithm for further processing based on the crowd density data.

In an embodiment, the density analysis manager 204 can cause the crowd counting system 100 to at least determine if a crowd density variation exists within the image based on a predetermined threshold for crowd density variation, and in response to a positive determination of the crowd density variation, partition the image into a plurality of image segments based on predefined crowd density ranges, each image segment corresponding to a predefined crowd density range. Additionally, wherein to determine if a crowd density variation exists within the image, the density analysis manager 204 can cause the crowd counting system 100 to divide the image into a plurality of tiles, determine a crowd density of each tile using the density classification algorithm, and compare a variation of the determined crowd densities against the predetermined threshold for crowd density variation. In an embodiment, wherein to divide the image into a plurality of tiles, the density analysis manager 204 can cause the crowd counting system 100 to divide the image into the plurality of tiles with an overlap between edges of adjacent tiles. In an embodiment, wherein to partition the image into the plurality of image segments, the density analysis manager 204 can cause the crowd counting system 100 to partition the image along edges of the plurality of tiles into the plurality of image segments based on the predefined crowd density ranges, wherein each image segment comprises one or more tiles and corresponds to a predefined crowd density range. In an embodiment, each predefined crowd density range is determined based on the crowd counting algorithm optimised for accuracy within said crowd density range. In an embodiment, the density analysis manager 204 can also cause the crowd counting system 100 to determine one or more environmental conditions of the image or the image segment.

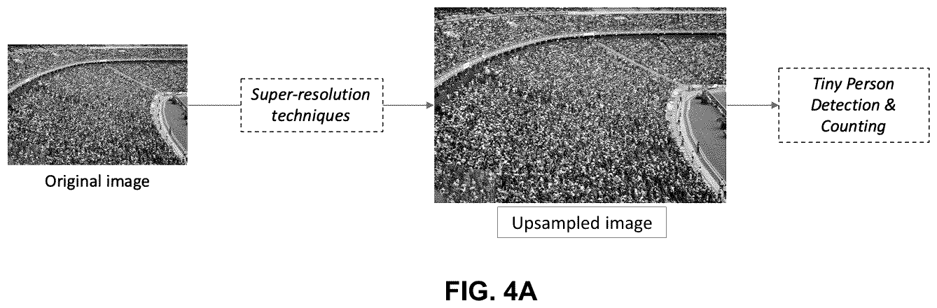

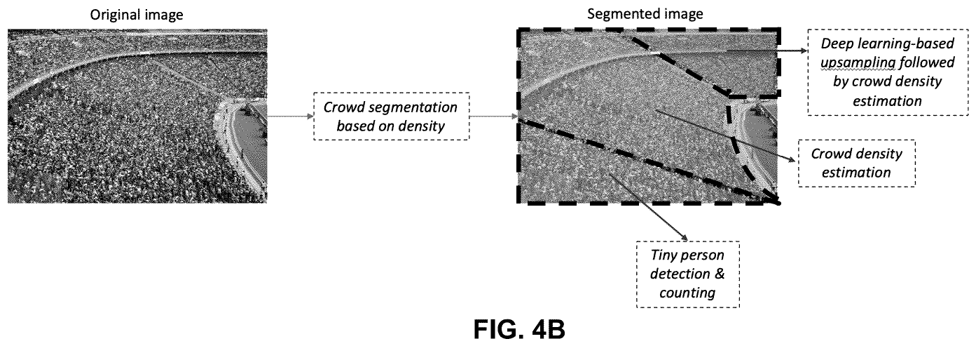

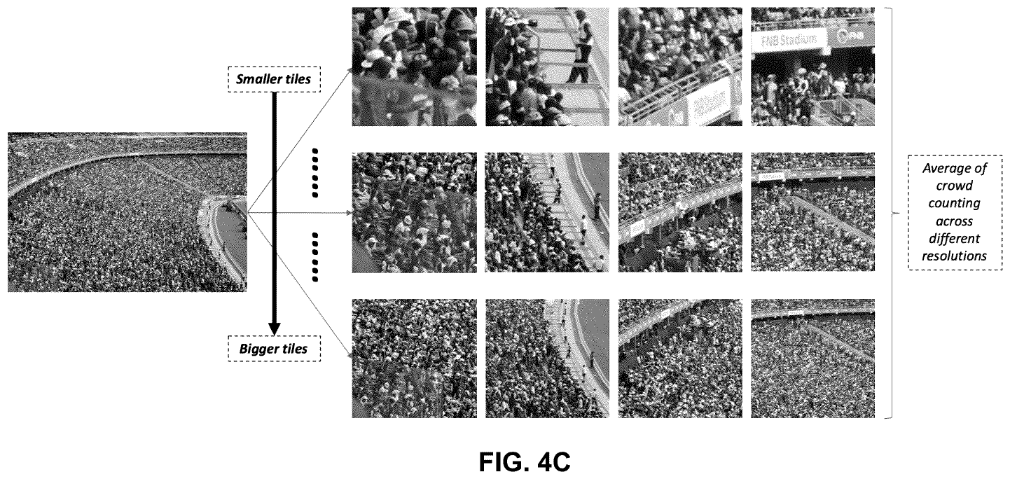

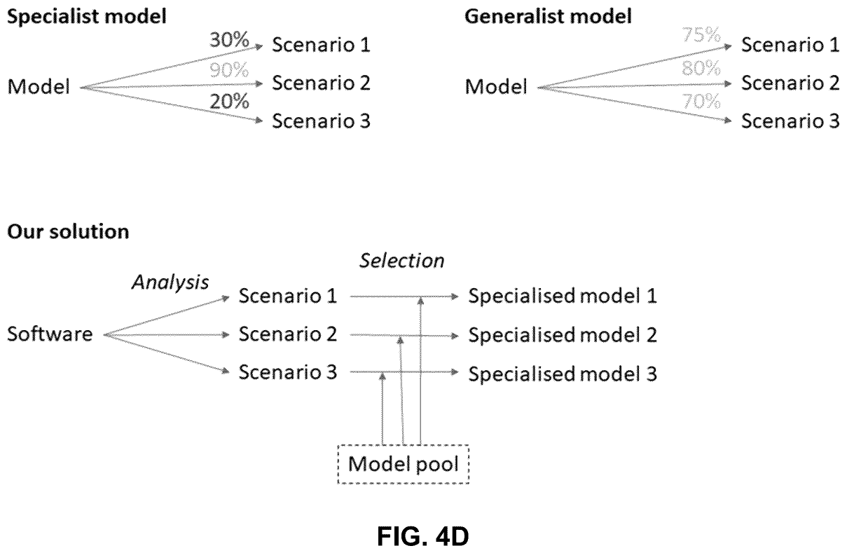

The model selection manager 206 in accordance with embodiments of the present disclosure can cause the crowd counting system 100 to select the most appropriate method or algorithm for further processing based on the crowd density data provided by the density analysis manager 204. As shown in FIG. 2, the model selection manager 206 can be configured to select either the super-resolution manager 208, estimation manager 210, or detector manager 212 as the next step in a crowd counting process. In an embodiment, the model selection manager 206 can cause the crowd counting system 100 to determine a crowd counting algorithm to be used to determine a crowd size within each image segment, based on the crowd density range of the image segment determined by density analysis manager 204. Each predefined crowd density range is associated with a respective crowd counting algorithm. For example, with reference to FIG. 4B, an image may be segmented into low, medium and high crowd density segments. For low crowd density segments, one or more of (i) tiny person detection and (ii) tiny face detection can be executed on the image segments, where bounding boxes are generated by the detector manager 212, and each bounding box can correspond to a single person to be counted by the counting manager 214. Where both tiny person detection and tiny face detection are used, the outputs including the bounding boxes are be overlayed to enable double counting avoidance. That is, if the bounding boxes on both layers overlap at the same area in the image (the relevant intersection-over-union threshold can be configurable), double counting is detected, and the person is only be counted once. Thus, the outputs can be combined to prevent double counting, with overlapping bounding boxes indicating a single individual based on a configurable intersection-over-union (IoU) threshold. The heuristic approach can be programmed as part of the counting manager 214. For medium crowd density segments, crowd estimation and counting methods can be applied by the estimation manager 210. In high crowd density segments, deep learning-based super-resolution processing methods can be applied by the super-resolution manager 208 to enhance image resolution, followed by crowd density estimation by the estimation manager 210. The segmentation-based approach can allow for tailored processing of different regions of the image and can improve the accuracy and efficiency of the crowd counting system 100.

In another embodiment, each of the above crowd counting algorithm can be associated with and optimised for one or more environmental conditions consisting of time, weather and location. The model selection manager 206 can cause the crowd counting system 100 to determine a crowd counting algorithm to be used to calculate a crowd size within each image segment, based on the crowd density range of the image segment and the one or more determined environmental conditions of the image or the image segment, as determined by density analysis manager 204.

In an embodiment, the super-resolution manager 208 can cause the crowd counting system 100 to perform image upsampling using super-resolution algorithms on image frames or one or more image segments. In an example embodiment, deep learning-based super-resolution methods, such as Real-ESRGAN, can be used to enhance the resolution of the image frames or segments. The system 100 can be configured to use other suitable image upsampling methods to improve the accuracy of crowd counting and density analysis. In other words, the super-resolution manager 208 can cause the crowd counting system 100 to upsample the image depicting a crowd before determining the crowd density variation and/or one or more of the plurality of image segments before determining the crowd size.

In an embodiment, the estimation manager 210 can cause the crowd counting system 100 to receive image frames either from the camera manager 202 or from the super resolution manager 208, depending on crowd density. The estimation manager 210 can cause the crowd counting system 100 to perform crowd density estimation by applying an appropriate crowd counting algorithm (e.g. with crowd estimation and counting methods).

In an embodiment, the detector manager 212 can cause the crowd counting system 100 to receive image frames or image segments and perform detection tasks, including crowd, person, or face detection, using a suitable detection algorithm. In an embodiment, the detector manager 212 can process the image frames to generate detection bounding boxes corresponding to the detected objects. The processed image frames, along with the detection bounding boxes, are then transmitted to the counting manager 214, which can cause the crowd counting system 100 to use the detection results from the detector manager 212 to perform crowd counting. In embodiments where tiny person or tiny face detection models are used, each bounding box can correspond to a single person. In an embodiment, for crowd detection models, the counting manager 214 can use crowd density estimation and counting methods to estimate the number of people within each detection bounding box.

Thus, in embodiments of the present disclosure, the estimation manager 210, the detector manager 212 and counting manager 214 can cause the crowd counting system 100 to determine a crowd size within each image segment using a crowd counting algorithm associated with crowd density range of the image segment, wherein each predefined crowd density range is associated with a respective crowd counting algorithm, and determine the crowd size in the image by summing the crowd size in each of the plurality of image segments. Moreover, in embodiments where each crowd counting algorithm is optimised for one or more environmental conditions consisting of time, weather and location, the estimation manager 210, the detector manager 212 and counting manager 214 can cause the crowd counting system 100 to determine the crowd size within each image segment using a crowd counting algorithm associated with crowd density range of the image segment and the one or more determined environmental conditions of the image.

In an example embodiment, as shown in FIG. 4B, the crowd counting application 200 can cause the crowd counting system 100 to perform segmented crowd counting, wherein the original image is divided into separate segments of different crowd density levels (e.g. including, but not limited to background, low crowd density, medium crowd density, and high crowd density). As discussed above, each predefined crowd density range can be determined based on the crowd counting algorithm optimised for accuracy within said crowd density range. To perform segmentation, the crowd counting system 100 can first split the image into multiple tiles, and each tile can be classified based on its crowd density using a crowd density estimation algorithm. The crowd counting system 100 can subsequently draw segmentation contours along the tiling borders based on the classification results, and optionally smoothen the contours using a smoothing spline. In an embodiment, the crowd counting system 100 can divide the image into portions of equal size during the tiling process, with the number of tiles determined by the image resolution. Once the image is segmented, different processing methods are applied to each segment based on its crowd density. For low crowd density segments, tiny person and tiny face detection and counting are performed using detection algorithms configured to detect small individuals and faces.

In an embodiment, both tiny person and tiny face detection can be executed sequentially on the same image, where bounding boxes are generated. The outputs including the bounding boxes are then overlayed to enable double counting avoidance—if the bounding boxes on both layers overlap at the same area in the image (the relevant intersection-over-union threshold can be configurable), double counting is detected, and the person is only be counted once. That is, the outputs can be combined to prevent double counting, with overlapping bounding boxes indicating a single individual based on a configurable intersection-over-union (IoU) threshold. The heuristic approach can be programmed as part of the counting manager 214.

For medium crowd density segments, crowd estimation and counting methods can be applied. In high crowd density segments, deep learning-based super-resolution processing methods can be applied by the super-resolution manager 208 to enhance image resolution, followed by crowd density estimation by the estimation manager 210. The segmentation-based approach can allow for tailored processing of different regions of the image and can improve the accuracy and efficiency of the crowd counting system 100.

In another example embodiment, the crowd counting application 200 can also cause the crowd counting system 100 to perform multi-scale crowd count averaging. The multi-scale crowd count averaging process can include tiling the image multiple times, each at a different resolution, wherein higher resolutions correspond to a smaller number of tiles, and lower resolutions correspond to a larger number of tiles. The tiling can also be configured to include a slight overlap between adjacent tiles to account for potential inaccuracies in crowd detection along the tile boundaries. The number of tiling processes can be pre-determined, with an increased number of tiling processes improving the accuracy of the crowd count at the expense of processing time (i.e. more tiling processes can result in more accurate but slower crowd count and estimation). Crowd estimation and counting can be performed on larger tiles, while tiny person and tiny face detection and counting can be performed on smaller tiles. The final crowd count is determined by averaging the crowd counts obtained from each resolution, with each tiling process contributing to the overall crowd estimation (i.e. each tiling process can generate one crowd count result, and the final crowd count result is the average of the crowd counts across all the tiling processes). In other words, in embodiments of the present disclosure, the crowd counting application 200 can cause the crowd counting system 100 to divide the image into at least a first set of tiles at a first resolution and a second set of tiles at a second resolution, and to determine the crowd size in the image by averaging the summed crowd size associated with the first set of tiles and the summed crowd size associated with the second set of tiles.

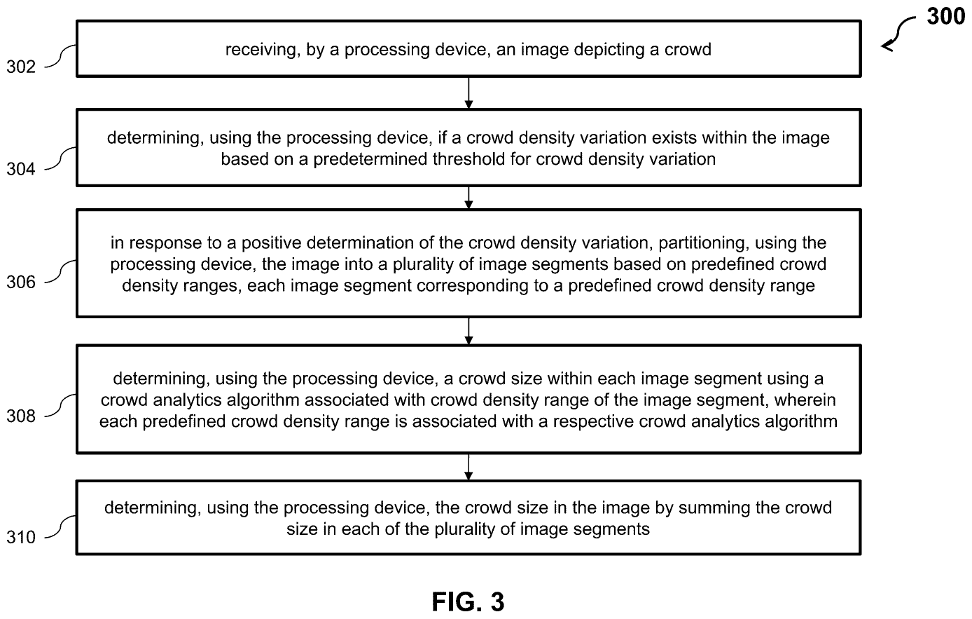

FIG. 3 shows a flowchart illustrating a method 300 of operating a crowd counting system, in accordance with embodiments of the disclosure. The method 300 can be implemented by the server 106 of system 100, hereinafter interchangeably referred to as a processing device. The method 300 broadly includes step 302 of receiving, by a processing device, an image depicting a crowd, step 304 of determining, using the processing device, if a crowd density variation exists within the image based on a predetermined threshold for crowd density variation, step 306 of partitioning, using the processing device, the image into a plurality of image segments based on predefined crowd density ranges, each image segment corresponding to a predefined crowd density range, in response to a positive determination of the crowd density variation, step 308 of determining, using the processing device, a crowd size within each image segment using a crowd counting algorithm associated with crowd density range of the image segment, wherein each predefined crowd density range is associated with a respective crowd counting algorithm and step 310 of determining, using the processing device, the crowd size in the image by summing the crowd size in each of the plurality of image segments.

Embodiments of the present disclosure can also include one or more features that provide advantages over existing solutions, as outlined below.

Automated Optimisation: Embodiments of the present disclosure can optimise crowd counting by analysing an image or video frame as described above and selecting the most suitable workflow to obtain accurate crowd count results based on predetermined or user defined requirements. Particularly, embodiments of the present disclosure can perform a preliminary analysis by tiling the image or video frame and applying a crowd density classification algorithm to assess whether crowd density is consistent or varies significantly, based on predetermined criteria (e.g. a user defined crowd density variation threshold, or a user-defined crowd density variation threshold or system-defined criteria, where the crowd counting system determines that a segmented counting process or multi-scale crowd counting process is more appropriate).

If crowd density is consistent, embodiments of the present disclosure can perform a super-resolution counting method to estimate crowd density, followed by tiny person detection and counting as described in the preceding paragraphs and as shown in FIG. 4A. If large variations in crowd density are detected, embodiments of the present disclosure can select one or more of the segmented counting process as described above and shown in FIG. 4B or a multi-scale crowd counting process as described above and as shown in FIG. 4C. The selection can be predetermined based on specific criteria, such as prioritisation of speed or accuracy. Alternatively, or in combination, manual selection of the method may be available following the preliminary analysis.

The mapping of crowd density range to the most appropriate crowd counting algorithm can determined by benchmark testing of the crowd counting algorithms, using both internal data and publicly available academic research. Embodiments of the present disclosure can also include configurable density thresholds for classifying crowd density levels within an image or video frame. These thresholds may be determined using a grid search algorithm, which is configured to maximise the accuracy of the selected crowd counting algorithm. The thresholds may vary based on factors such as time of day, weather conditions, and whether the setting is indoors or outdoors. The grid search algorithm can provide distinct thresholds as the appropriate crowd counting algorithm may differ depending on these variables

Generalisable Solution: Embodiments of the present disclosure can address limitations of traditional crowd counting methods which lack generalisability. These existing methods are typically designed to tackle a specific scenario and do not perform well in other scenarios. On the other hand, generalised crowd counting methods typically do not perform optimally in any specific scenario. Embodiments of the present disclosure can resolve this dilemma by selecting the most appropriate crowd counting method based on the analysis of the image data, overcoming the limitations of existing solutions which are often tailored to specific problems and lack generalisability.

In FIG. 4D, a specialist model refers to a model that has been trained specifically for a single task using a focused dataset, while a generalist model is one that is trained to complete several tasks using a sparse collection of datasets. In FIG. 4D, scenarios 1, 2, and 3 refer to three different crowd counting scenarios. For example, scenario 1 refers to high crowd density at an outdoor stadium in daytime, scenario 2 refers to low crowd density at the same outdoor stadium at nighttime, and scenario 3 refers to high crowd density in a shopping mall illuminated by incandescent lights. For simplicity, only three scenarios are shown in FIG. 4D, but in practical applications, the number of crowd counting scenarios varies and can extend to several dozen. The percentages displayed indicate the evaluation accuracy of the trained models, for example, 90% means that the model has achieved an accuracy of 90% on that specific crowd counting task. The second portion labelled “our solution” illustrates use of a model pool, which comprise a collection of specialised models that are fine-tuned using specific datasets to be deployed for different scenarios. In FIG. 4D, specialised models 1, 2, and 3 represent models trained for specific conditions. For instance, specialised model 1 focuses on crowd density estimation for outdoor, sunny conditions; specialised model 2 is tailored for outdoor, nighttime scenarios; and specialised model 3 is designed for detecting small individuals in indoor environments with incandescent lighting. In an example embodiment, there may be several crowd counting algorithms in each category, and several datasets can be used to train specialised models that cater for the varying weather conditions, time of the day, indoor/outdoor light exposure, etc.). With reference to examples in FIG. 4D, specialised model 1 can be a model that specialises in crowd density estimation for outdoor, sunny scenarios, specialised model 2 can be a model that specialises in detecting people in outdoor and nighttime scenarios, and specialised model 3 can be a model that specialises in tiny person detection for indoor environments lit up by incandescent lights. In short, the model pool comprises of a large number of models where each model specialises in crowd density estimation or person detection under different conditions.

Various methods have been developed to address the problem of crowd counting, either through scenario-specific methods or by employing generic methods applicable across multiple scenarios. However, both approaches have inherent limitations. Using scenario-specific crowd counting methods requires the fine-tuning of several models for different scenarios. On the other hand, training a single model to handle all scenarios can result in reduced accuracy for specific cases. Furthermore, maintaining a single generalist model can be problematic as data imbalance can result in the model performing well for one scenario but significantly worse for another scenario. Embodiments of the present disclosure can overcome these challenges by integrating specialised methods within a unified framework. This framework includes a workflow that analyses the input data and selects the most suitable crowd counting algorithm for the given scenario. The approach can ensure accurate crowd counting across a wide range of conditions. Additionally, the framework is designed to accommodate further methods or algorithms for comprehensive crowd analysis. As shown in FIG. 4D, embodiments of the present disclosure can provide a balance between accuracy and generalisation, enabling high performance across diverse scenarios. Moreover, embodiments of the present disclosure can offer cost and time efficiency to end users by providing a single, adaptable solution capable of functioning effectively in various environments.

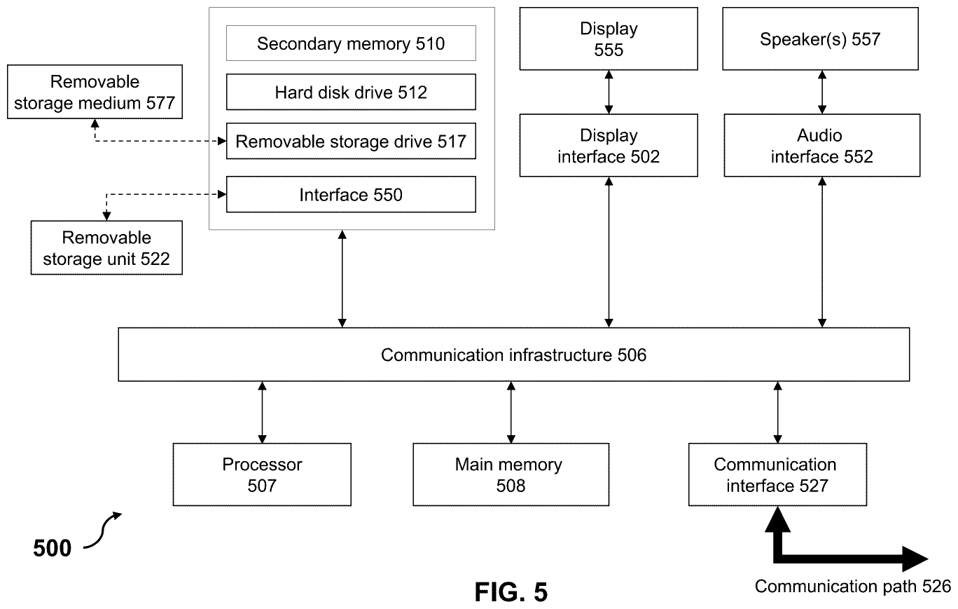

FIG. 5 depicts an exemplary computing device 500, hereinafter interchangeably referred to as a computer system 500, where one or more such computing devices 500 may be used to execute the method 400 of FIG. 4. One or more components of the exemplary computing device 500 can also be used to implement the system 100. The following description of the computing device 500 is provided by way of example only and is not intended to be limiting.

As shown in FIG. 5, the example computing device 500 includes a processor 507 for executing software routines. Although a single processor is shown for the sake of clarity, the computing device 500 may also include a multi-processor system. The processor 507 is connected to a communication infrastructure 506 for communication with other components of the computing device 500. The communication infrastructure 506 may include, for example, a communications bus, cross-bar, or network.

The computing device 500 further includes a main memory 508, such as a random access memory (RAM), and a secondary memory 510. The secondary memory 510 may include, for example, a storage drive 512, which may be a hard disk drive, a solid state drive or a hybrid drive and/or a removable storage drive 517, which may include a magnetic tape drive, an optical disk drive, a solid state storage drive (such as a USB flash drive, a flash memory device, a solid state drive or a memory card), or the like. The removable storage drive 517 reads from and/or writes to a removable storage medium 577 in a well-known manner. The removable storage medium 577 may include magnetic tape, optical disk, non-volatile memory storage medium, or the like, which is read by and written to by removable storage drive 517. As will be appreciated by persons skilled in the relevant art(s), the removable storage medium 577 includes a computer readable storage medium having stored therein computer executable program code instructions and/or data.

In an alternative implementation, the secondary memory 510 may additionally or alternatively include other similar means for allowing computer programs or other instructions to be loaded into the computing device 500. Such means can include, for example, a removable storage unit 522 and an interface 550. Examples of a removable storage unit 522 and interface 550 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 522 and interfaces 550 which allow software and data to be transferred from the removable storage unit 522 to the computer system 500.

The computing device 500 also includes at least one communication interface 527. The communication interface 527 allows software and data to be transferred between computing device 500 and external devices via a communication path 526. In various embodiments of the inventions, the communication interface 527 permits data to be transferred between the computing device 500 and a data communication network, such as a public data or private data communication network. The communication interface 527 may be used to exchange data between different computing devices 500 which such computing devices 500 form part an interconnected computer network. Examples of a communication interface 527 can include a modem, a network interface (such as an Ethernet card), a communication port (such as a serial, parallel, printer, GPIB, IEEE 1394, RJ45, USB), an antenna with associated circuitry and the like. The communication interface 527 may be wired or may be wireless. Software and data transferred via the communication interface 527 are in the form of signals which can be electronic, electromagnetic, optical or other signals capable of being received by communication interface 527. These signals are provided to the communication interface via the communication path 526.

As shown in FIG. 5, the computing device 500 further includes a display interface 502 which performs operations for rendering images to an associated display 550 and an audio interface 552 for performing operations for playing audio content via associated speaker(s) 557.

As used herein, the term “computer program product” may refer, in part, to removable storage medium 577, removable storage unit 522, a hard disk installed in storage drive 512, or a carrier wave carrying software over communication path 526 (wireless link or cable) to communication interface 527. Computer readable storage media refers to any non-transitory, non-volatile tangible storage medium that provides recorded instructions and/or data to the computing device 500 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 500. Examples of transitory or non-tangible computer readable transmission media that may also participate in the provision of software, application programs, instructions and/or data to the computing device 500 include radio or infra-red transmission channels as well as a network connection to another computer or networked device, and the Internet or Intranets including e-mail transmissions and information recorded on Websites and the like.

The computer programs (also called computer program code) are stored in main memory 508 and/or secondary memory 510. Computer programs can also be received via the communication interface 527. Such computer programs, when executed, enable the computing device 500 to perform one or more features of embodiments discussed herein. In various embodiments, the computer programs, when executed, enable the processor 507 to perform features of the above-described embodiments. Accordingly, such computer programs represent controllers of the computer system 500.

Software may be stored in a computer program product and loaded into the computing device 500 using the removable storage drive 517, the storage drive 512, or the interface 550. The computer program product may be a non-transitory computer readable medium. Alternatively, the computer program product may be downloaded to the computer system 500 over the communication path 526. The software, when executed by the processor 507, causes the computing device 500 to perform the necessary operations to execute the method 400 as shown in FIG. 4.

It is to be understood that the embodiment of FIG. 5 is presented merely by way of example to explain the operation and structure of the system 500. Therefore, in some embodiments one or more features of the computing device 500 may be omitted. Also, in some embodiments, one or more features of the computing device 500 may be combined together. Additionally, in some embodiments, one or more features of the computing device 500 may be split into one or more component parts.

It will be appreciated that the elements illustrated in FIG. 5 function to provide means for performing the various functions and operations of the system as described in the above embodiments.

When the computing device 500 is configured to realise the system 100 to process one or more natural language video analytics commands, the system 100 will have a non-transitory computer readable medium having stored thereon an application which when executed causes the system 100 to perform steps comprising: (i) receiving, by a processing device, an image depicting a crowd, (ii) determining, using the processing device, if a crowd density variation exists within the image based on a predetermined threshold for crowd density variation, (iii) partitioning, using the processing device, the image into a plurality of image segments based on predefined crowd density ranges, each image segment corresponding to a predefined crowd density range in response to a positive determination of the crowd density variation, (iv) determining, using the processing device, a crowd size within each image segment using a crowd counting algorithm associated with crowd density range of the image segment, wherein each predefined crowd density range is associated with a respective crowd counting algorithm and (v) determining, using the processing device, the crowd size in the image by summing the crowd size in each of the plurality of image segments.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A crowd counting system, the system comprising:
at least one processor; and
at least one memory including computer program code;
wherein the at least one processor, at least one memory and the computer program code are configured to allow the system to:
receive an image depicting a crowd;
determine if a crowd density variation exists within the image based on a predetermined threshold for crowd density variation;
in response to a positive determination of the crowd density variation;
partition the image into a plurality of image segments based on predefined crowd density ranges, each image segment corresponding to a predefined crowd density range;
determine a crowd size within each image segment using a crowd counting algorithm associated with crowd density range of the image segment, wherein each predefined crowd density range is associated with a respective crowd counting algorithm; and
determine the crowd size in the image by summing the crowd size in each of the plurality of image segments.

2. The crowd counting system as claimed in claim 1, wherein to determine if a crowd density variation exists within the image, the system is configured to:
divide the image into a plurality of tiles;
determine a crowd density of each tile using a density classification algorithm; and
compare a variation of the determined crowd densities against the predetermined threshold for crowd density variation.

3. The crowd counting system as claimed in claim 2, wherein to divide the image into a plurality of tiles, the system is configured to:
divide the image into the plurality of tiles with an overlap between edges of adjacent tiles.

4. The crowd counting system as claimed in claim 2, wherein to partition the image into the plurality of image segments, the system is configured to:
partition the image along edges of the plurality of tiles into the plurality of image segments based on the predefined crowd density ranges, wherein each image segment comprises one or more tiles and corresponds to a predefined crowd density range.

5. The crowd counting system as claimed in claim 2, wherein to divide the image into a plurality of tiles, the system is configured to divide the image into a first set of tiles at a first resolution and a second set of tiles at a second resolution; and
wherein to determine the crowd size in the image, the system is configured to determine the crowd size in the image by averaging the summed crowd size associated with the first set of tiles and the summed crowd size associated with the second set of tiles.

6. The crowd counting system as claimed in claim 1, wherein each predefined crowd density range is determined based on the crowd counting algorithm optimised for accuracy within said crowd density range.

7. The crowd counting system as claimed in claim 1, wherein each crowd counting algorithm is optimised for one or more environmental conditions consisting of time, weather and location; and
wherein to determine the crowd size within each image segment, the system is configured to:
determine one or more environmental conditions of the image or the image segment; and
determine the crowd size within each image segment using a crowd counting algorithm associated with crowd density range of the image segment and the one or more determined environmental conditions of the image or the image segment.

8. The crowd counting system as claimed in claim 1, wherein the system is further configured to upsample the image depicting a crowd before determining the crowd density variation and/or one or more of the plurality of image segments before determining the crowd size.

9. The crowd counting system as claimed in claim 1, wherein the image comprises a video frame depicting the crowd, the video frame being one of a plurality of video frames extracted from a video stream.

10. A method of operating a crowd counting system, the method comprising:
receiving, by a processing device, an image depicting a crowd;
determining, using the processing device, if a crowd density variation exists within the image based on a predetermined threshold for crowd density variation;
in response to a positive determination of the crowd density variation;
partitioning, using the processing device, the image into a plurality of image segments based on predefined crowd density ranges, each image segment corresponding to a predefined crowd density range;
determining, using the processing device, a crowd size within each image segment using a crowd counting algorithm associated with crowd density range of the image segment, wherein each predefined crowd density range is associated with a respective crowd counting algorithm; and
determining, using the processing device, the crowd size in the image by summing the crowd size in each of the plurality of image segments.

11. The method as claimed in claim 10, wherein the step of determining if a crowd density variation exists within the image comprises:
dividing, using the processing device, the image into a plurality of tiles;
determining, using the processing device, a crowd density of each tile using a density classification algorithm; and
comparing, using the processing device, a variation of the determined crowd densities against the predetermined threshold for crowd density variation.

12. The method as claimed in claim 11, wherein the step of dividing the image into the plurality of tiles comprises dividing, using the processing device, the image into the plurality of tiles with an overlap between edges of adjacent tiles.

13. The method as claimed in claim 11, wherein the step of partitioning the image into the plurality of image segments based on the predefined crowd density ranges comprises:
partitioning, using the processing device, the image along edges of the plurality of tiles into the plurality of image segments based on the predefined crowd density ranges, wherein each image segment comprises one or more tiles and corresponds to a predefined crowd density range.

14. The method as claimed in claim 11, wherein the step of dividing the image into a plurality of tiles comprises dividing, using the processing device, the image into a first set of tiles at a first resolution and a second set of tiles at a second resolution; and
wherein the step of determining the crowd size in the image comprises determining, using the processing device, the crowd size in the image by averaging the summed crowd size associated with the first set of tiles and the summed crowd size associated with the second set of tiles.

15. The method as claimed in claim 10, wherein each predefined crowd density range is determined based on the crowd counting algorithm optimised for accuracy within said crowd density range.

16. The method as claimed in claim 10, wherein each crowd counting algorithm is optimised for one or more environmental conditions consisting of time, weather and location; and
wherein the step of determining the crowd size within each image segment using a crowd counting algorithm associated with crowd density range of the image segment comprises:
determining, using the processing device, one or more environmental conditions of the image; and
determining, using the processing device, the crowd size within each image segment using a crowd counting algorithm associated with crowd density range of the image segment and the one or more determined environmental conditions of the image.

17. The method as claimed in claim 10, the method further comprising upsampling, using the processing device, the image depicting a crowd before determining the crowd density variation and/or one or more of the plurality of image segments before determining the crowd size.

18. The method as claimed in claim 10, wherein the image comprises a video frame depicting the crowd, the video frame being one of a plurality of video frames extracted from a video stream.
